(19) United States
(12) Patent Application Publication
(10) Pub. No.: US 2011/0007311 A1
(43) Pub. Date: Jan. 13, 2011

(54) METHOD AND ARRANGEMENT FOR THE TIME-RESOLVED SPECTROSCOPY USING A PHOTON MIXING DETECTOR

(75) Inventor: Nico Correns, Weimar (DE)

Correspondence Address: FISH & RICHARDSON P.C. (BO), P.O. BOX 1022, MINNEAPOLIS, MN, 55440-1022, US

(73) Assignee: CARL ZEISS MICROIMAGING GMBH, Jena (DE)

(21) Appl. No.: 12/920,624

(22) PCT Filed: Feb. 21, 2009
(86) PCT No.: PCT/EP2009/001263

§ 371 Date: Sep. 2, 2010

(30) Foreign Application Priority Data
Mar. 5, 2008 (DE) 102008012635.7

(51) Int. Cl. G01J 3/30; G01J 3/28

(52) U.S. Cl. 356/317; 356/326

(57) ABSTRACT

The present invention relates to a solution for time-resolved spectroscopy, wherein the sample to be analyzed is illuminated by a modulated light source, and the spectrum reflected therefrom is recorded in a time-resolved manner and evaluated. In the method according to the invention for time-resolved spectroscopy, a sample to be analyzed is irradiated by a modulated light source having short light pulses, and the radiation emitted by the sample is represented via imaging optical elements and a spectral-selective element on a sensor disposed in the image plane, and the signals thereof are evaluated by a control and regulating unit, and/or stored. The sensor disposed in the image plane is a PMD sensor, which in addition to the intensity values also determines the running times of the radiation emitted by the sample, and forwards the same to the control and regulating unit. Although PMD sensors were originally intended for object recognition, particularly in traffic, the use thereof in many other technical fields is conceivable and advantageous. The solution provided herein describes the use of PMD sensors in spectroscopy, particularly for the time-resolved analysis of samples. However, the use of PMD sensors is also possible in Raman spectrometry, or for the measurement of luminescence, such as for differentiating phosphorescence and fluorescence light.

The present invention concerns an arrangement for time-resolved spectroscopy, in which the sample being investigated is illuminated by a modulated light source and the spectrum reflected from it recorded and evaluated in time-resolved fashion.

Spectroscopy is understood to mean the generation, observation and recording of spectra emitted or absorbed from a sample as radiation, including their analysis and interpretation. The performed spectroscopic investigations then furnish information about the elements or compounds present in the investigated sample and permit assertions concerning interaction between matter and radiation. Depending on the resolution capacity, spectral- and time-resolved spectroscopy can then be distinguished.

Time-resolved spectroscopy refers to a measurement method from the field of spectroscopy, in which the time changes of spectral properties of a system are investigated. For this purpose, short light pulses are sent to the sample being investigated and their optical properties determined by means of transmission, emission or frequency conversion of the electromagnetic radiation.

The sample is placed in a defined state of excitation by an intense, short light pulse. Through further, time-delayed light pulses, the state changes of the sample are then investigated based on the first light impulse (query).

Whereas conclusions can be drawn concerning the dynamics of the process by varying the delay time between the excitation and query pulse, different processes can be set in motion in the investigated sample by varying the excitation wavelength, which can lead to different spectral and time signatures.

Measurement tasks that cannot be conducted with non-time-resolved spectroscopy can be accomplished with such an excitation-query principle.

Numerous solutions are known according to the prior art for time-resolved spectroscopy.

So-called photomultipliers as sensors are then primarily used as detectors. These sensors are also referred to as PMT sensors (from the English: photomultiplier light detector) and generate an electronic current in reaction to the arriving photon-fluorescence movement. PMT sensors do have a high data read-out rate, which permits the sample to be quickly scanned, but PMT sensors have an extremely low quantum efficiency, especially in the near-infrared range of the electromagnetic spectrum.

For these reasons, solutions are also known in the prior art, in which CCD detectors are used instead of PMT sensors.

Since the generally two-dimensional CCD detectors are used here not for image recording, but for pure light recognition and the light of the individual spots is imaged on the individual pixels via several confocally active diaphragms, the depth effect of the field of a PMT-based spot scanner is retained, so that the very high quantum efficiency of CCD detectors is fully effective as an additional advantage.

Methods and devices for time-resolved fluorescence spectroscopy, in which laser light from a single pulse is used to excite fluorescing photons in a sample, are described in U.S. Pat. No. 4,855,930 A.

The measurement arrangements then consist of a pulsed light source for excitation of the sample, optical filters to isolate the fluorescence light emitted by the sample and a photocell for detection of this fluorescence light and generation of an electrical signal, as well as a control unit to process the information and analyze the data. A highly sensitive sensor for very weak light signals, a so-called photomultiplier, is used here as photocell. Even individual light quanta, on encountering the photo-sensitive layer, release photoelectrons that are multiplied in cascade fashion to produce a measurable signal at the end. The actual fluorescence pulse response f(t) must be mathematically filtered out by the control unit from the pulse response E(t) of the system. Although repeated excitations are not required in the described solution, so that digital data can be recorded in an extremely short time, the solution is quite costly and does not reach the desired accuracy.

A time-resolved mass spectrometer based on an ion source is described in U.S. Pat. No. 5,969,350 A. The sample image is displayed via a digital camera on a computer monitor. Since excitation of the sample occurs with ions, a vacuum is required for analysis. This has the drawback that either a demanding sample change unit is required or that a number of samples must be introduced simultaneously to the vacuum chamber. The proposed solution represents a solution for use in the laboratory and is not very suitable in practice, because of the required vacuum chamber. Rapid measured value recording is scarcely possible, especially with multiple samples.

A method and device for time-resolved spectroscopy based on the use of a fast photosensor are described in U.S. Pat. No. 6,564,076 B1. By measuring the rise and decay of short light pulses, determination of the concentration of an absorbent pigment, like hemoglobin, for example, is made possible. By additional determination of the duration of the light pulses, changes in concentration of the pigment in real time can be accurately determined. For this purpose, the sensor is also combined here with a photomultiplier. Although digital data can also be recorded with this solution in an extremely short time, the solution is quite expensive and does not reach the desired accuracy.

The solution described in U.S. Pat. No. 6,740,890 B1 also pertains to measurement of the time trend of radiation initiated by a light pulse in a sample. To detect the light emitted by the sample, a CCD camera with a slit mask was used. Here again, it is possible to record the entire decay curve of fluorescence of the sample with a single light pulse. The proposed solution is particularly suited for DNA and protein studies.

The invention described in U.S. Pat. No. 6,806,455 B2 concerns an arrangement and method for imaging, time-resolved fluorescence, especially of biochemical and medical samples. The device has an objective with a large opening, a flash lamp for illumination, a digital camera with a fast detector with high quantum efficiency and a computer. Simultaneous, time-resolved imaging of a number of samples is possible with this solution with high sensitivity and high throughput.

A method and an arrangement for performance of time-resolved spectroscopy with a confocal laser spot array is described in U.S. Pat. No. 6,979,830 B2. The solution is then suitable for any spectroscopy application and is not restricted to microscopy and laser scanning cytometry (LSC). In contrast to the previously described solutions, the sample is scanned here by laser spots, using a CCD detector. The fact that the laser power is divided into several spots has an adverse effect in this solution. Identical power density in the individual spots can only be attained with difficulty.

An adverse effect in the known technical solutions is that the instrument expense for time-resolved spectroscopy is quite high and is generally suitable only for one wavelength (channel) or for a small number of wavelengths (channels).

The underlying task of the invention is to develop an arrangement for time-resolved spectroscopy that permits investigation of samples with the broadest possible bandwidth and speed. The arrangement should then have the simplest, most cost-effective and most reliable possible instrument design.

The task is solved according to the invention by the features of the independent claims. Preferred modifications and embodiments are the object of the dependent claims.

A new optoelectronic detector, the so-called photonic mixer device (PMD), was developed by the Institute for Communications Processing (INV) and the Center for Sensor Systems (ZESS).

Relative to the known optoelectronic detectors, the measurement process in the PMD, i.e. the mixing and corresponding process, is integrated in the detector. A matrix of PMD pixels also records the phase (and therefore the time trend) of the received light, in addition to the amplitude.

Although PMD sensors were originally proposed for object recognition, especially in traffic, their use in many other technical fields is conceivable and expedient. With the solution proposed here, the use of PMD sensors in spectroscopy is described, especially time-resolved investigation of samples. The use of PMD sensors, however, is also possible in Raman spectrometry or for luminescence measurement, for example to distinguish phosphorescence and fluorescence light.

By additional evaluation of the time of flight of the light emitted by the sample, the intensity of the illumination can be reduced or the measurement layout significantly simplified in different measurement methods. Many measurement methods, in which extremely high illumination intensities are required, become possible for the first time on this account. Materials with very similar optical properties, for example, can be reliably distinguished by additional evaluation of the time of flight of the light emitted from the sample.

In principle, the use of PMD sensors is possible in spectroscopy for all measurement methods, in which interactions of the illuminated sample that can be distinguished in time are produced by modulated illumination.

Laser scanning microscopes and confocal microscopes, in which PMD sensors can be used for imaging and/or selection of individual substances, are conceivable as additional areas of application.

A PMD sensor system is based on the principles of intensity measurement and time-of-flight measurement and therefore forms an active system, in which an illumination unit illuminates the sample to be measured with modulated light. The emitted light is reflected from individual or several points of the sample and goes back to the PMD sensor with a phase shift dependent on time of flight. The PMD sensors are also modulated with the frequency of the illumination unit and mixed with the modulation signal with the phase-shifted light signal from the sample. The distance to the points of the sample is obtained pixel-by-pixel from the phase shift that occurred as a result of time of flight.

A PMD sensor simultaneously produces the raw data for determination of the distance values and their gray value in the spectral range for all image points. The PMD sensor therefore furnishes two images of each considered sample, whose information content can be utilized with high synergy.

The invention is further described below by means of practical examples. For this purpose:

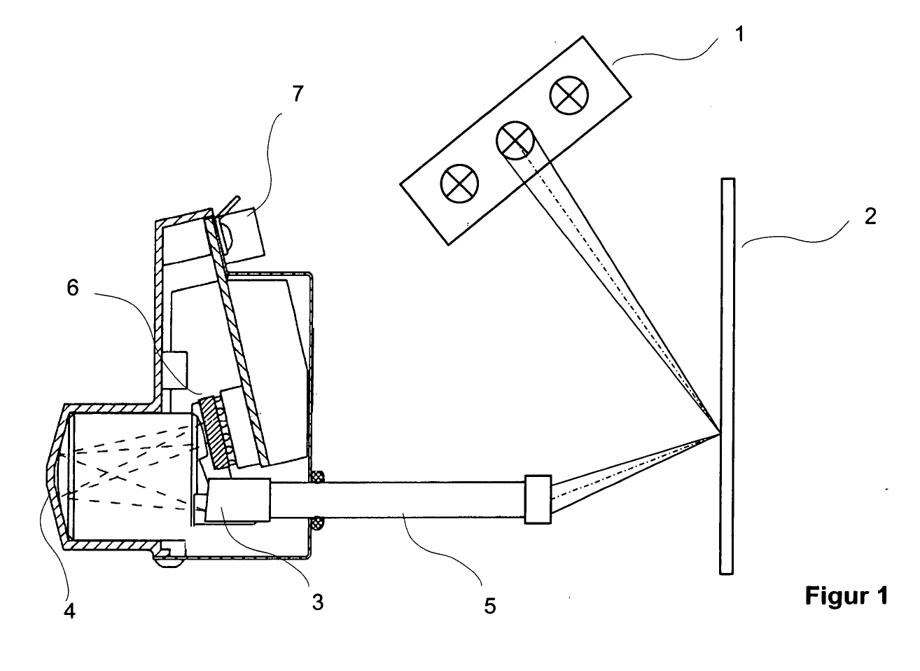

FIG. 1 shows an arrangement for time-resolved spectroscopy, using an inlet gap with a diffraction grating and

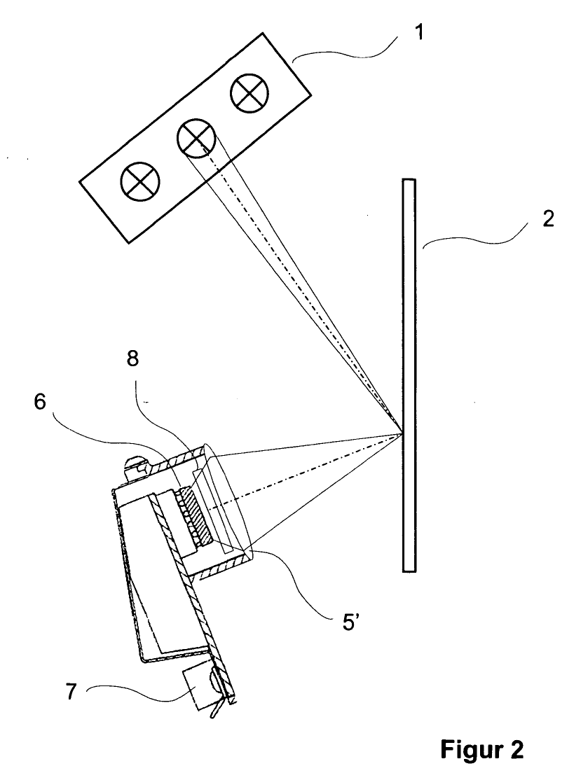

FIG. 2 shows an arrangement for time-resolved spectroscopy, using a graduated filter.

In the method for time-resolved spectroscopy according to the invention, a sample being investigated is irradiated by a light source capable of being modulated with short light pulses and the radiation emitted by the sample is imaged on a sensor arranged in the image plane via imaging optical elements and a spectrally selective element, and whose signals are evaluated and/or stored by a control and regulation unit. The sensor arranged in the image plane is then a PMD sensor, which determines the time-of-flight of the radiation emitted by the sample, in addition to the intensity values, and sends them to the control and regulation unit for evaluation.

Individual light sources in the form of emitting semiconductor light sources that are spectrally different are used here as a light source capable of being modulated. These can be LEDs, OLEDs or laser diodes, for example.

The variants for the spectrally selective element are seen in the use of an inlet gap with a diffraction grating and/or a prism or graduated filter. Whereas use of an inlet gap with an imaging grating occurs in known fashion and arrangement, an employed graduated filter is arranged directly in front of or directly on the PMD sensor. In the simplest case, a prism can replace the diffraction grating, in which case it serves for spectral splitting of wavelength regions, in order to image them on the detector. However, it is also possible to use a prism as an additional optical element with a diffraction grating. The light of a point light source or its individual orders can be split spectrally and imaged on the detector side-by-side.

The PMD sensor can be designed line-like, but preferably matrix-like. The photons converted to electrons by the PMD sensor coupled to the light source capable of being modulated are separated in time-selective fashion pixel-by-pixel as a function of reference signal in the light-sensitive semiconductor area. Through this simple comparison process between the optical measurement and the electronic reference signal, the resulting output signal of the PMD sensor already represents a direct reference to the time change of the spectral properties. The PMD sensor simultaneously permits intensity distribution to be provided for each image point of the spectrum.

In a first advantageous embodiment, the individual light sources in the method according to the invention are connected by the control and regulation unit, so that the radiation emitted from the sample is imaged in time succession via the imaging optical elements and the spectrally selected elements in the form of individual spectra on the line- or matrix-like PMD sensor.

The optical measurement arrangement, consisting of the imaging optical elements, the spectrally selective element and the PMD sensor, is preferably designed so that the individual spectra can be imaged on the fullest possible surface on the PMD sensor.

In a simple variant, the PMD sensor is designed line-like and has 160 pixels. The sample being investigated is irradiated by a light source capable of being modulated with short light pulses of a specified wavelength. The radiation emitted from a measurement point of the sample is then imaged on the PMD sensor via imaging optical elements and the spectrally selective element (full surface).

In an improved variant, the PMD sensor is designed matrix-like and has a surface of 120×160 pixels. The radiation emitted from a measurement point of the sample can also be imaged over the entire surface on the PMD sensor. For this purpose, the spectrally selective element must be designed so that the different orders of the light emerging from the measurement point are imaged next to each other over the entire surface on the PMD sensor. This has the advantage of high spectral resolution. Time-staggered engagement of the modulated light source supports the effect of the spectrally selective element and offers the advantage of improved separation of the individual wavelength regions.

In a second advantageous embodiment in the method for time-resolved spectroscopy, the individual light sources are connected by the control and regulation unit, so that the radiation emitted from the sample is simultaneously imaged side-by-side in the form of individual spectra on the matrix-like PMD sensor via the imaging optical elements and the spectrally selective element.

For this purpose, the PMD sensor is designed matrix-like and has a surface of 120×160 pixels. The sample being investigated is irradiated by a light source capable of being modulated with short light pulses of specific wavelength. The radiation emitted by a number of measurement points of a line on the sample is then simultaneously imaged side-by-side on the PMD sensor via the imaging optical elements and the spectrally selective element. In the ideal case, each spectrum is also imaged here on a line, so that with a surface of 120×160 pixels, 120 spectra can be imaged simultaneously. In order to increase the resolution of the measurement, however, it is also possible to image each spectrum on several lines. The simultaneous imaging of the spectra has the advantage of very rapid measurement. The spectrally selective element is then designed accordingly. Measurements in the nanosecond range can be achieved with a PMD sensor with a detector surface of 120×160 pixels.

The arrangement according to the invention for time-resolved spectroscopy consists of a light source capable of being modulated for illumination of the sample being investigated with short light pulses, a spectrally selective element, imaging optical elements, a sensor arranged in the image plane and a control and regulation unit. The sensor arranged in the image plane is then a PMD sensor, which also determines the time-of-flight of the radiation emitted from the sample, in addition to the intensity values, and sends it to the control and regulation unit for evaluation.

Individual light sources in the form of emitting semiconductor light sources that are spectrally different are used here as a light source capable of being modulated. These can be LEDs, OLEDs or laser diodes, for example.

In a first variant of the invention, an inlet gap with a diffraction grating and/or a prism is used as a spectrally selective element and in a second variant a graduated filter is used. Whereas use of an inlet gap with an imaging grating occurs in known fashion and arrangement, an employed graduated filter is arranged directly in front of or directly on the PMD sensor. In the simplest case, a prism can replace the diffraction grating, or it can serve during additional use between the diffraction grating and sensor to split the individual orders and image them next to each other on the detector.

The PMD sensor can be designed line-like, but preferably matrix-like. The photons converted to electrons by the PMD sensor coupled to the light source capable of being modulated are separated time-selectively pixel-by-pixel as a function of the reference signal still in the light-sensitive semiconductor area. Through this simple comparison process between the optical measurement and the electronic reference signal, the resulting output signal of the PMD sensor already represents a direct reference to the time change of the spectral properties. The PMD sensor simultaneously permits the intensity distribution to be provided for each image point of the spectrum.

FIG. 1 shows an arrangement for time-resolved spectroscopy, using an inlet gap with a diffraction grating. The arrangement here consists of a light source 1 capable of being modulated for illumination of the sample 2 being investigated with short light pulses, an inlet gap 3 serving as a spectrally selective element with a diffraction grating 4, an optical fiber 5 serving as imaging optical element, a PMD sensor 6 arranged in the image plane and a control and regulation unit (not shown), which can be connected to the electronic interface 7. The inlet gap 3 is designed here as coupling-out optics of an optical fiber 5, from which the radiation coming from sample 2 is imaged on the PMD sensor 6 via the diffraction grating 4. The PMD sensor 6 also determines the values for time-of-flight of the radiation emitted by the sample 2, in addition to the intensity values, and sends them to the control and regulation unit for evaluation.

FIG. 2 shows a second arrangement for time-resolved spectroscopy, using a graduated filter. As already mentioned, a graduated filter is arranged directly in front of or directly on the PMD sensor. The arrangement here consists of a light source 1 capable of being modulated for illumination of the sample 2 being investigated with short light pulses, a graduated filter 8 serving as a spectrally selective element, an imaging optical element 5′, a PMD sensor 6 arranged in the image plane and a control and regulation unit (not shown), which can be connected to the electronic interface 7. The radiation coming from the sample 2 is imaged on the PMD sensor 6 via the graduated filter 8, which also determines the values for the time-of-flight of the radiation emitted from the sample 2, in addition to the intensity values, and sends them to the control and regulation unit for evaluation.

As already stated, in a first advantageous embodiment, the individual light sources are engaged and disengaged by the control and regulation unit so that the radiation emitted by the sample is imaged in time succession on the PMD sensor via the imaging optical elements and the spectrally selective element in the form of individual spectra.

The optical measurement arrangement, consisting of the imaging optical elements, the spectrally selective element and the PMD sensor, is then preferably designed so that the individual spectra can be imaged over the fullest possible surface on the PMD sensor.

In a simple variant, the PMD sensor is designed line-like and has, for example, 160 pixels. The sample being investigated is irradiated by a light source capable of being modulated with short light pulses of a certain wavelength. The radiation emitted from a measurement point of the sample is then imaged on the PMD sensor (full surface) via imaging optical elements and the spectrally selective element.

In an improved variant, the PMD sensor is designed matrix-like and has a surface, for example, of 120×160 pixels. The radiation emitted from a measurement point of the sample can also be imaged over the entire surface on the PMD sensor. For this purpose, the spectrally selective element must be designed so that the different orders of the light emerging from a measurement point are imaged next to each other over the entire surface of the PMD sensor. This has the advantage of high spectral resolution. The time-staggered engagement of the modulated light source supports the effect of the spectrally selective element and offers the advantage of improved separation of the individual wavelength regions.

In a second advantageous embodiment, the individual light sources are engaged by the control and regulation unit so that the radiation emitted by the sample is imaged simultaneously next to each other on the PMD sensor via the imaging optical elements and the spectrally selective element in the form of individual spectra.

For this purpose, the PMD sensor is designed matrix-like and has a surface, for example, of 120×160 pixels. The sample being investigated is irradiated by a light source capable of being modulated with short light pulses of a certain wavelength. The radiation emitted from a series of measurement points of a line on the sample is then imagined simultaneously next to each other on the PMD sensor via the imaging optical elements and the spectrally selective element. In the ideal case, each spectrum is also imaged here on a line, so that 120 spectra can be simultaneously imaged on a surface of 120×160 pixels. To increase the resolution of the measurement, however, it is also possible to image each spectrum on several lines. Simultaneous imaging of the spectra has the advantage of very rapid measurement. The spectrally selective element is then designed accordingly. Measurements in the nanosecond range can be achieved with a PMD sensor with a detector surface of 120×160 pixels.

The special internal structure of the PMD sensors permits elimination of the fraction of unmodulated light already before time-of-flight evaluation, so that interfering outside light can be suppressed.

Depending on the type of excitation-query principle conducted in time-resolved spectroscopy, different conclusions concerning the investigated sample can be drawn by evaluation of the corresponding measurement results.

For example, by varying the delay time between the excitation and query pulse, conclusions can be drawn concerning the dynamics of the process. If the measurement quantity obtained in this variation of the delay time is plotted against the delay time, a so-called transient is obtained.

In contrast to this, when the excitation wavelength is varied, different processes in the investigated system are generally set in motion, which can lead to other spectral and time signatures. Plotting of the system response versus the query wavelength at fixed delay time yields a so-called transient spectrum. The response of the system can then be produced either by variation of the wavelength of a relatively narrow-band query pulse or by spectrally-resolved detection of a broadband query pulse.

With the technical solution according to the invention, an arrangement and method are made available for time-resolved spectroscopy, which permits investigation of samples with the broadest possible band and speed, in which the arrangement for this purpose has the simplest, most cost-effective and most reliable possible instrument layout.

Relative to an ordinary, currently available measurement system for time-resolved spectroscopy, the acquisition costs with similar functionality are reduced to about 1/50.

1-14. (canceled)

15. A method, comprising:
using a light source to irradiate a sample with short light pulses so that the sample emits radiation;
using imaging optical elements and a spectrally selective element to image radiation emitted by the sample via transmission and/or reflection on a PMD sensor arranged in an image plane;
evaluating and/or storing signals from the PMD sensor via a control and regulation unit, the signals from the PMD sensor including: time-of-flight information for the radiation emitted by the sample; and intensity values of the radiation emitted by the sample; and
sending the time-of-flight information and intensity values to the control and regulation unit for evaluation.

16. The method according to claim 15, wherein the method comprises using imaging optical elements and a spectrally selective element to image the radiation emitted by the sample on the PMD sensor.

17. The method according to claim 15, wherein the light source comprises semiconductor light emitting sources that are spectrally different.

18. The method according to claim 15, wherein:
the spectrally selective element is selected from the group consisting of a diffraction grating, a prism and a graduated filter; and
the spectrally selective element is in an inlet gap.

19. The method according to claim 15, wherein:
the spectrally selective element comprises a diffraction grating and a prism; and
the spectrally selective element is in an inlet gap.

20. The method according to claim 15, wherein the PMD sensor has a line-like design or a matrix-like design.

21. The method according to claim 15, wherein the light source comprises individual light sources in communication with the control and regulation unit so that the radiation emitted by the sample is imaged in time succession on the PMD sensor in the form of individual spectra via the imaging optical elements and the spectrally selective element.

22. The method according to claim 15, wherein the light source comprises individual light sources in communication with the control and regulation unit so that the radiation emitted by the sample is imaged simultaneously on the PMD sensor in the form of individual spectra via the imaging optical elements and the spectrally selective element.

23. An arrangement, comprising:
a light source configured to illuminate a sample with short light pulses to cause the sample to emit radiation;
a PMD sensor arranged in an image plane, the PMD sensor being configured to detect radiation emitted by the sample in transmission and/or reflection; and
a control and regulation unit,
wherein:
the PMD sensor is configured to determine time-of-flight information for the radiation emitted by the sample;
the PMD sensor is configured to determine intensity values for the radiation emitted by the sample; and
the PMD sensor is configured to send the time-of-flight information and intensity values to the control and regulation unit.

24. The system according to claim 23, further comprising:
a spectrally selective element; and
imaging optical elements,
wherein the spectrally selective element and the imaging optical elements are configured to image the radiation emitted by the sample on the PMD sensor.

25. The arrangement according to claim 23, wherein the light source comprises semiconductor light emitting sources that are spectrally different.

26. The arrangement according to claim 23, wherein:
the spectrally selective element is selected from the group consisting of a diffraction grating, a prism and a graduated filter; and
the spectrally selective element is in an inlet gap.

27. The arrangement according to claim 23, wherein:
the spectrally selective element comprises a diffraction grating and a prism; and
the spectrally selective element is in an inlet gap.

28. The arrangement according to claim 23, wherein the PMD sensor has a line-like design or a matrix-like design.

29. The arrangement according to claim 23, wherein the light source comprises individual light sources in communication with the control and regulation unit so that the radiation emitted by the sample is imaged in time succession on the PMD sensor in the form of individual spectra via the imaging optical elements and the spectrally selective element.

30. The arrangement according to claim 23, wherein the light source comprises individual light sources in communication with the control and regulation unit so that the radiation emitted by the sample is imaged simultaneously on the PMD sensor in the form of individual spectra via the imaging optical elements and the spectrally selective element.

31. A method, comprising:
using a PMD to collect information about radiation emitted from a sample in a time-resolved fashion.

32. The method of claim 31, wherein the information about the radiation emitted from the sample includes time-of-flight information about the radiation emitted from the sample.

33. The method of claim 32, wherein the information about the radiation emitted from the sample includes an intensity of the radiation emitted from the sample.

34. The method of claim 32, further comprising exposing the sample to light to generate the radiation emitted from the sample.
